(19) United States
(12) Patent Application Publication
(10) Pub. No.: US 2026/0044175 A1
(43) Pub. Date: Feb. 12, 2026

(54) Abacus

(71) Applicant: Uy Ngu, Plano, TX (US)

(72) Inventor: Uy Ngu, Plano, TX (US)

(21) Appl. No.: 18/795,204

(22) Filed: Aug. 6, 2024

(51) Int. Cl. G06C 1/00

(52) U.S. Cl. CPC G06C 1/00

(57) ABSTRACT

An abacus comprising a base, a first post and a second post mounted vertically on the base, and a plurality of rails coupled between the first post and the second post. Each of the plurality of rails is configured to receive a removable token that is slidably mounted on each rail. Each rail has a substantially flat cross-section. The cross-section of the rail is tilted at an angle between a vertical position and a horizontal position to enable gravity to keep a removable token mounted on the rail.

### TECHNICAL FIELD

The present application relates generally to an abacus or counting frame suitable for tracking expenses.

### BACKGROUND

Budgeting tools exist in many shapes and form. The most basic tracking method is pen and paper, which uses a written budget in a ledger. This method is very tedious and requires the user to dedicate a fair amount of time to reconcile the expenses. This method does not prevent the user from overspending and can introduce human errors. Another tracking tool is the envelope method, which entails putting cash into envelopes marked for major budget categories, such as groceries, clothing, and entertainment. The user is only allowed to spend the money allocated in the given envelope. The user is allowed to move money between envelopes and stops spending when cash is exhausted. The method prevents the user from going over budget but is not practical due to cashless transactions and online purchases.

The spreadsheet method is a more advanced version of the pen and paper method. A spreadsheet allows the user to create graphs and other visuals of the budget and expenses on a computer screen. This method requires some basic spreadsheet skills and requires dedicated computer time to reconcile expenses. Tracking credit card transactions can be very time consuming. The spreadsheet method does not prevent the user from overspending, nor does it prevent accidental transaction omissions.

Budgeting software or apps operate on a computer or smartphone. They are more powerful than a spreadsheet in that the software can link credit cards and bank accounts to track expenses. These can create charts to provide a visual aid. This method does not prevent the user from overspending. These also require the user to manually enter cash transactions.

An abacus is a two-dimensional array of beads (or similar objects) that slide on rods built into a frame. Each bead may represent one digit of a multi-digit number using a positional numeral system, such as base ten. An abacus may be used to perform mathematical calculations including addition, subtraction, multiplication, and division. The beads are first arranged to represent a number and are then manipulated to perform a mathematical operation with another number. The final position of the beads can be read as the result.

In ancient times, an abacus was primarily used as a counting device. It allowed users to count and track large numbers, especially in commerce and money collection. With the advancement of technology, abacuses have been phased out. Abacuses are not portable like the calculator in a smart phone. Some training is required to properly use an abacus. Proficient abacus users cannot compete with the speed of a pocket calculator.

### SUMMARY

The present disclosure describes an improved abacus that provides a visual representation of a budget and that tracks spending. The abacus comprises a frame with flat parallel rails or rods for mounted tokens. The tokens are different colors and represent different dollar values. The tokens are flat as opposed to rounded beads and have a slot for easy removal from the rails. Different colored tokens create a visual of a budget for different categories. A category can use multiple color tokens to account for the budget. For example, if the user budgets $1,000 for food, the section can use 10 black tokens at $100 each or a combination of black, green, blue, red, and white tokens up to $1,000. As the user spends money, he slides the corresponding value of tokens from left to right.

It is a primary object of the present disclosure to provide an abacus comprising: i) a base; ii) a first post and a second post mounted vertically on the base; iii) a plurality of rails coupled between the first post and the second post, wherein each of the plurality of rails is configured to receive a removable token that is slidably mounted on each rail.

In one embodiment, a first one of the plurality of rails has a substantially flat cross-section.

In another embodiment, the cross-section of the first rail is tilted at an angle between a vertical position and a horizontal position.

In still another embodiment, the cross-section of the first rail is tilted at an angle of approximately 45 degrees.

In yet another embodiment, the angle of the cross-section of the first rail may be rotatably adjusted between the vertical position and the horizontal position.

In a further embodiment, the first rail includes a first end that is inserted into a first hole in the first post and a second end that is inserted into a second hole in the second post.

In a still further embodiment, the first hole in the first post includes a first gasket that provides a friction grip for the first end of the first rail and the second hole in the second post includes a second gasket that provides a friction grip for the second end of the first rail.

In a yet further embodiment, the cross-section of the first rail is configured to allow the first rail to be inserted into a slot in a first removable token.

In another embodiment, the cross-section of the first rail is configured to enable the first removable token to slide between the first and second posts on the first rail.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view of the front of an abacus or counting frame according to an embodiment of the disclosure.

FIG. 2 is an exploded view of the rear of the abacus in FIG. 1 according to an embodiment of the disclosure.

FIG. 3A is a front elevational view of the abacus according to an embodiment of the disclosure.

FIG. 3B is a cross-sectional view of the abacus according to an embodiment of the disclosure.

FIG. 4 is a perspective view of an abacus token according to an embodiment of the disclosure.

FIG. 5 illustrates multiple front views and side views of abacus tokens according to an embodiment of the disclosure.

### DETAILED DESCRIPTION

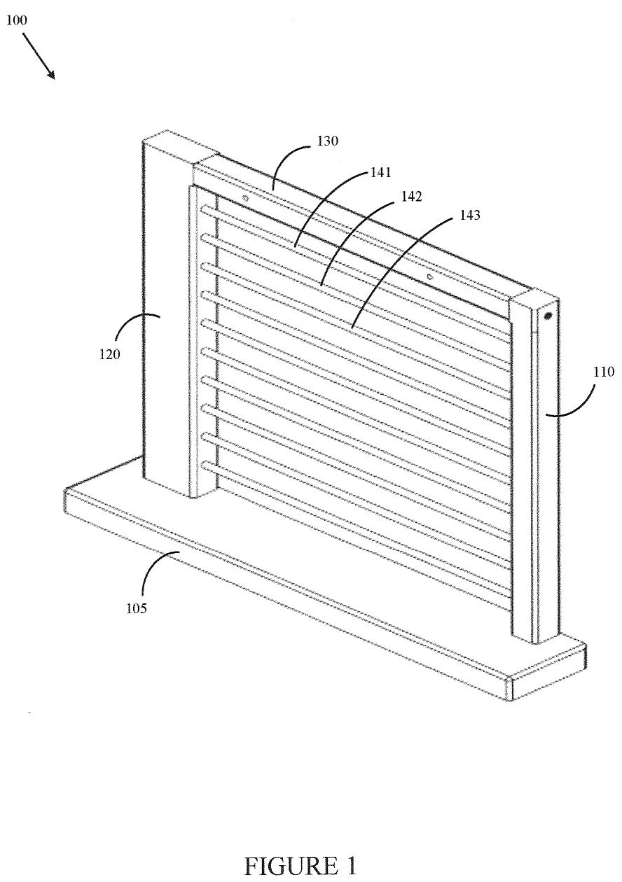

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged abacus (or counting frame).

Conventional abacuses lack removeable tokens and do not indicate currency denominations by text characters or by colors. Conventional abacuses do not include an angled token rail. The present disclosure describes an improved abacus, also called a counting frame, that is useful in tracking expenses. The abacus includes slanted rails, each rail having a substantially flat cross-sectional area. In place of conventional abacus beads, the present disclosure implements tokens, wherein each token includes a slot that allows the token to be slidably mounted on the slanted flat rails. The slot and flat rail enable a token to be easily removed from the rail. The tokens may be different colors to represent different currency denominations.

FIG. 1 is a perspective view of the front of abacus (or counting frame) 100 according to an embodiment of the disclosure. In an exemplary embodiment, abacus 100 includes right vertical post 110 and left vertical post 120 that are mounted vertically on base 105. Top post 130 is connected between vertical posts 110 and 120. In an exemplary embodiment, abacus 100 may be approximately 17 inches wide and 16 inches high and made of wood. Abacus 100 may stand freely on a tabletop or may be mounted to a wall. A plurality of rails (or rods), including example rails 141-143, extend between vertical posts 110 and 120.

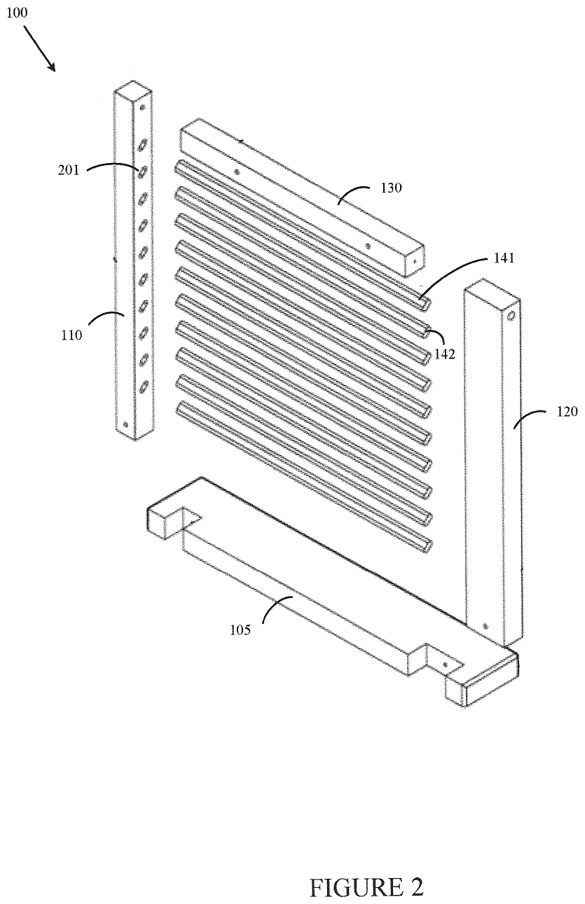

FIG. 2 is an exploded view of the rear of abacus 100 in FIG. 1 according to an embodiment of the disclosure. The rails, including example rails 141-143, do not have a round cross-sectional area. Instead, according to the principles of the present invention, each of the rails has a substantially flat cross-sectional area. As explained below in greater detail, this feature enables a token having a slot therein to be removably mounted on, for example, rail 142 without sliding off if the abacus is moved or tilted. Each of posts 110 and 120 includes a series of aligned slots or holes, such exemplary hole 201, that enable the rails to be mounted between posts 110 and 120.

A conventional abacus may have a single color of beads fixed to round dowels. The beads cannot be removed without disassembly of the frame. However, as shown in FIGS. 2, abacus 100 includes flat rails, wherein each rail is mounted between posts 110 and 120 and is tilted at a 45-degree angle. The tokens are flat cylindrical shapes that include a slot. The slot allows the token to be mounted and removed without disassembly of the frame.

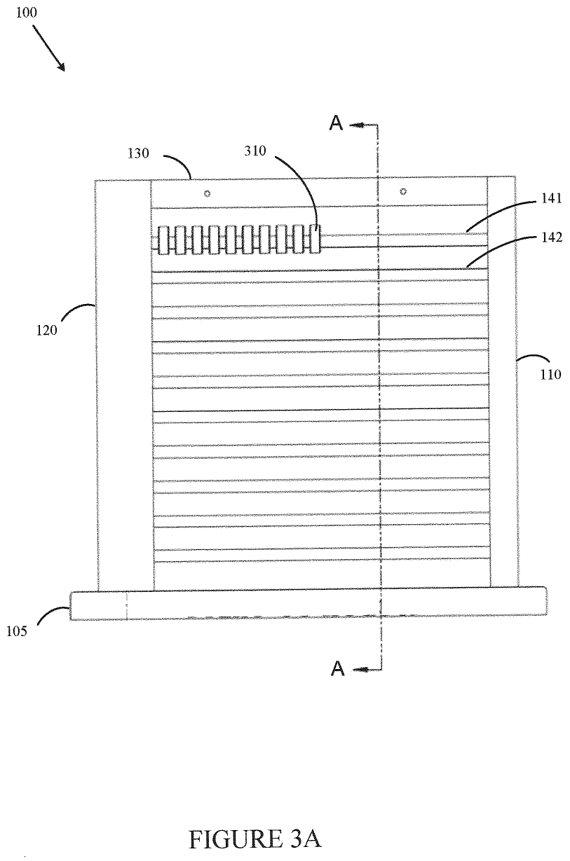

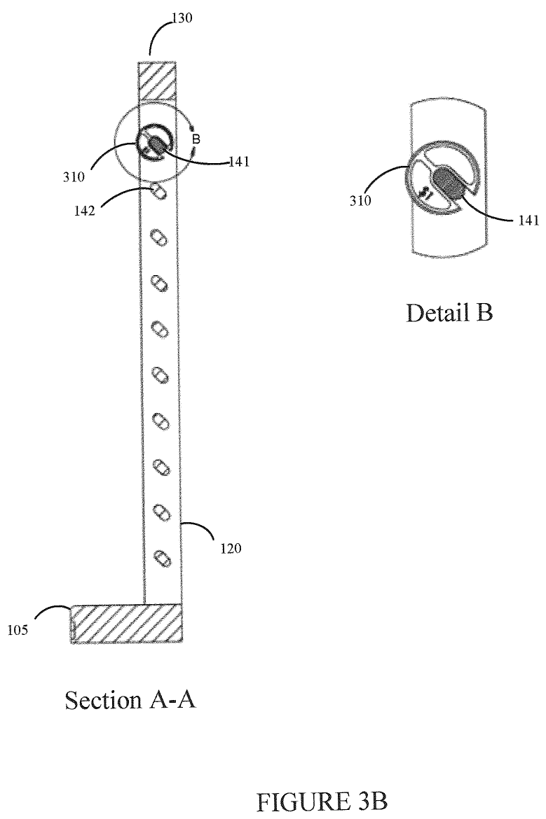

FIG. 3A is a front elevational view of abacus 100 according to an embodiment of the disclosure. FIG. 3B is a cross-sectional view of abacus 100 according to an embodiment of the disclosure. A plurality of tokens, such as example token 310, are shown on the rails of abacus 100. In the example, each token is removably mounted on example rail 141 and may slide left to right on rail 141. Cross-sectional view A-A shows token 310 mounted on rail 141, which is shaded dark in Detail B of FIG. 3B. Example token 310 has the characters “$1” printed on the side, indicated that token 310 is a one dollar ($1) token.

As Detail B illustrates, rail 141 has a flat cross-sectional area with rounded edges. Additionally, rail 141 is tilted at approximately a 45-degree angle so that the token 310 is held in place by gravity on rail 141. According to an exemplary embodiment, the angle at which a rail is tilted may be adjusted between 0 degrees (horizontal) and 90 degrees (vertical). This may be accomplished by inserting rubber gaskets (not shown) in the holes 201 in posts 110 and 120. A rail may be twisted to a desired angle by the user and then the rubber gaskets in the holes 201 in posts 110 and 120 provide a friction grip that holds the rail at the desired angle.

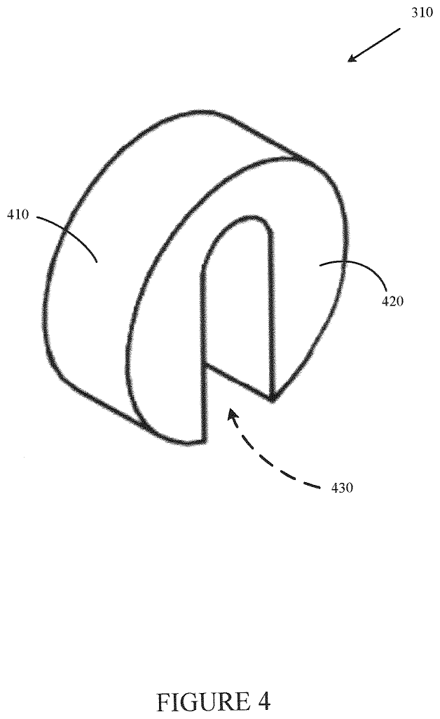

FIG. 4 is a perspective view of abacus token 310 according to an embodiment of the disclosure. Token 310 is approximately cylinder-shaped with a perimeter surface 410, a top surface 420, and a bottom surface (not shown) opposite top surface 420. A slot 430 (indicated by a dotted line arrow) is formed in the body of token 310 to receive a rail, such as rail 141.

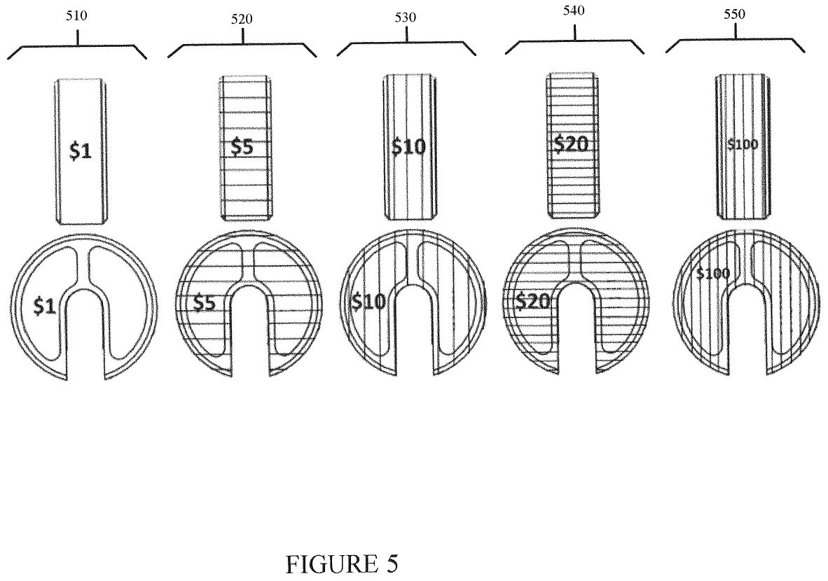

FIG. 5 illustrates multiple front views and side views of abacus tokens according to an embodiment of the disclosure. Horizontal and vertical lines of different spacing are used to indicate color of tokens.

Token 510 is a token having a value of one dollar. The characters “$1” may be printed on the perimeter surface as well as the top and bottom surfaces of token 510. Token 510 may be colored white in an example embodiment.

Token 520 is a token having a value of five dollars. The characters “$5” may be printed on the perimeter surface as well as the top and bottom surfaces of token 520. The widely spaced horizontal line pattern of token 520 may indicate the color red.

Token 530 is a token having a value of ten dollars. The characters “$10” may be printed on the perimeter surface as well as the top and bottom surfaces of token 530. The widely spaced vertical line pattern of token 540 may indicate blue.

Token 540 is a token having a value of twenty dollars. The characters “$20” may be printed on the perimeter surface as well as the top and bottom surfaces of token 540. The narrowly spaced horizontal line pattern of token 540 may indicate green.

Token 550 is a token having a value of one hundred dollars. The characters “$100” may be printed on the perimeter surface as well as the top and bottom surfaces of token 550. The narrowly spaced vertical line pattern of token 550 may indicate the color black.

According to an embodiment of the present disclosure, the characters printed on the perimeter surface of the tokens are positioned such that the characters are visible towards the front of abacus 100 when the tokens are mounted on the rails. Thus, the positions of the characters are determined by the angle of slot 430 and the rails. For example, if rail 141 is tilted (by default) at a 45-degree angle, the “$1” characters on the perimeter surface of token 510 are printed in a position that faces out towards the front of abacus 100 when rail 141 is at 45 degrees.

The disclosed abacus 100 differs from the conventional budgeting tools in that it addresses a few deficiencies. One deficiency of prior art budgeting tools is the out of sight, out of mind situation. The conventional budgeting tools can easily be put away or closed, like software applications, and forgotten about. The disclosed abacus has a physical presence. It is designed to be placed on a tabletop or hung on a wall, making it highly visible and kept front and center for everyone to see. It is a daily reminder of the budget.

Another deficiency of conventional budgeting tools is the lack of communication. When a family member buys groceries, that person gets a receipt. When the person arrives home, he or she slides the corresponding token value under the grocery section to the right. If he spends $24.40, he can round up and slide $25 of tokens to the right. With tokens 310 valued in US currency, it is easy to perform quick math steps. The disclosed abacus 100 communicates to the other family members that $25 was spent and indicates how much money remains on the left side. The rounding up also adds a savings component to the budget. When the user has a partial dollar spend like $23.40, he rounds up his token value to the nearest dollar denomination of his choice. By rounding the spend up to $25.00, the user automatically saves $1.60.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An abacus comprising:
a base;
a first post and a second post mounted vertically on the base;
a plurality of rails coupled between the first post and the second post, wherein each of the plurality of rails is configured to receive a removable token that is slidably mounted on the each rail.

2. The abacus as set forth in claim 1, wherein a first one of the plurality of rails has a substantially flat cross-section.

3. The abacus as set forth in claim 2, wherein the cross-section of the first rail is tilted at an angle between a vertical position and a horizontal position.

4. The abacus as set forth in claim 3, wherein the cross-section of the first rail is tilted at an angle of approximately 45 degrees.

5. The abacus as set forth in claim 3, wherein the angle of the cross-section of the first rail may be rotatably adjusted between the vertical position and the horizontal position.

6. The abacus as set forth in claim 5, wherein the first rail includes a first end that is inserted into a first hole in the first post and a second end that is inserted into a second hole in the second post.

7. The abacus as set forth in claim 6, wherein the first hole in the first post includes a first gasket that provides a friction grip for the first end of the first rail and the second hole in the second post includes a second gasket that provides a friction grip for the second end of the first rail.

8. The abacus as set forth in claim 3, wherein the cross-section of the first rail is configured to allow the first rail to be inserted into a slot in a first removable token.

9. The abacus as set forth in claim 8, wherein the cross-section of the first rail is configured to enable the first removable token to slide between the first and second posts on the first rail.
